(19) United States
(12) Patent Application Publication
(10) Pub. No.: US 2013/0024784 A1
(43) Pub. Date: Jan. 24, 2013

(54) SYSTEMS AND METHODS FOR LIFE TRANSITION WEBSITE

(71) Applicant: Ivy Lifton, Venice, FL (US)

(72) Inventor: Ivy Lifton, Venice, FL (US)

(21) Appl. No.: 13/552,183

(22) Filed: Jul. 18, 2012

Related U.S. Application Data
(60) Provisional application No. 61/508,737, filed on Jul. 18, 2011.

(51) Int. Cl. G06F 3/01

(52) U.S. Cl. 715/753

(57) ABSTRACT

A method for producing a website includes publishing a website including a plurality of forums for users to post messages, wherein each of the plurality of forums is directed to a specific topic, receiving a message to post on the website, associating the message with at least one of the specific topics, and providing an option to post the message to each of the plurality of forums directed to the at least one of the specific topics.

### RELATED APPLICATIONS

This application claims priority under 35 U.S.C. §119(e) to U.S. Provisional Patent Application Ser. No. 61/508,737, entitled “SYSTEMS AND METHOD FOR LIFE TRANSITION WEBSITE,” filed on Jul. 18, 2011, which application is herein incorporated by reference in its entirety.

### BACKGROUND

There are many social networking websites in use today that allow users to communicate with multiple friends simultaneously. For example, Facebook allows users to select their friends and share online postings with friends. Other social networking web sites allow members of a particular community or group to join and share questions and comments with each other. For example, a member of a group may start an online website using Bigtent (http://www.bigtent.com/) or Yahoo Groups 10 (http://groups.yahoo.com/). There are also many websites dedicated to a particular medical condition or disease. For example, there is a website dedicated to Alzheimer's disease (http://www.alz.org/). These sites post information about the condition, and often include recent news or research regarding the condition. Some web sites dedicated to a particular condition or disease also include a forum or message board where viewers can post questions or comment on others' questions.

### SUMMARY

Although community and group web sites exist, it would be beneficial to connect users who share a common life experience or are undergoing a similar life transition. Additionally, it would be beneficial to provide users with a personalized website interface to record their thoughts and emotions relative to the life experience. It may be therapeutic for the user to record and share their thoughts relating to the life experience. Furthermore, it would be beneficial for a particular user to access several different types of forums at a single website. Accordingly, systems and methods are provided for a website that provides a personalized experience for users to post and/or read comments about life events relevant to a specific topic.

In one example, systems and methods are provided for users who have Alzheimer's disease to share their experiences with each other, while spouses of people with Alzheimer's disease may have a separate forum to share their experiences, and children of people with Alzheimer's disease may have another separate forum to share their experiences. In one example, users who have Alzheimer's disease, their spouses and their children all share the same Alzheimer's disease forum. According to one example, a user may post and/or read comments on several forums. The several forums can be separate forums with the user can associate. For example, a user may post and/or read comments on a forum for fathers of teenagers and also post and/or read comments on a forum for spouses of breast cancer patients.

Additionally, it would be beneficial for users to have a place to post comments without sharing the comments with others. In this aspect, the website may serve as a journal for a user to chronicle thoughts and emotions. A user may choose to share the comments when the user enters them or at a later time. According to one aspect, the website may assist people dealing with major and minor life events. For instance, according to one embodiment, the website provides a way for a user to formally recognize a life event and help the user move forward.

According to one embodiment, a user may be permitted to create private web pages to which journaling posts may be sent. A user may define one or more users that may access the private web pages to read and share thoughts with other users. In one embodiment, multiple users may be permitted to post their experiences and thoughts. In one example, family members may create a separate forum where they can share their experiences. Postings to private forums may selectively be shared to other forums by the user that submits the posting.

According to one feature, the website is a Process Specific Social Networking website. In particular, the social networking features of the website relate to a process the person is going through. The person's life experiences relevant to the specific process are tracked on the website, and optionally shared with others.

Furthermore, users may be presented an interface having a timeline of postings that can be selectively viewed by the user. For instance, if a user was going through a difficult period in her life, she can review the postings to determine the emotional experiences throughout the period. Also, in one implementation, a user may be permitted to merge different timelines each associated with different forums. For instance, it may be helpful to the user to see his collective postings to see his collective life experiences on a single timeline. In one implementation, a user may merge her posts from a specific forum with one or more other users to create an Integrated Process Specific Timeline. For example, three sibling users who have a parent with Alzheimer's disease may share posts with each other, and one of the users may choose to view a timeline of the posts from all three sibling users relevant to the parent's Alzheimer's disease.

According to one embodiment, a method for producing a website is provided, comprising publishing a website including a plurality of forums for users to post messages, wherein each of the plurality of forums is directed to a specific topic. The method includes allowing users to post at least one personal message privately to the website, associating the at least one personal message with a specific topic, and presenting to the users the opportunity to post the at least one personal message to the forum associated with the specific topic. According to one feature, the website may be configured as an application for use on a smart phone or a tablet computer.

According to one embodiment, a method for producing a website includes publishing a website including a plurality of forums for users to post messages, wherein each of the plurality of forums is directed to a specific topic, receiving a message to post on the website, associating the message with at least one of the specific topics, and providing an option to post the message to each of the plurality of forums directed to the at least one of the specific topics.

According to one embodiment, the method further includes associating a first message received from a first user with a first specific topic and a second message received from a second user with a second specific topic.

According to one embodiment, associating the message with at least one of the specific topics includes parsing the message for keywords and determining the at least one of the specific topics related to the keywords.

According to one embodiment, associating the message with at least one of the specific topics comprises receiving, from a user, an indication of the at least one of the specific topics with which the message is associated.

According to one embodiment, the method further comprises presenting, to a user, a plurality of messages posted by the user, the messages directed to at least one of the specific topics, wherein the messages are ordered chronologically according to a time of posting of each message.

According to one embodiment, the plurality of forums includes a forum specific to each user. The method may further comprise receiving, from a user, permission for one or more other users to access the forum specific to the user. The method may further comprise publishing a forum comprising a subset of the forums specific to the users, wherein the subset comprises forums specific to the users for which all the users to which the forums are specific have permission to access all other forums in the subset.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE FIGURES

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a main webpage according to one embodiment of the present invention;

FIG. 2 shows a webpage including a textbox according to one embodiment of the invention;

FIG. 3 shows a webpage of a general forum according to one embodiment of the invention;

FIG. 4 shows a webpage of an Alzheimer's disease forum according to one embodiment of the invention;

FIG. 5 shows a transitional webpage according to one embodiment of the invention;

FIG. 6 shows a private user webpage according to one embodiment of the invention;

FIG. 7 shows a webpage including chronological display of a user's posts, according to one embodiment of the invention;

FIG. 8 shows an example computer system with which various aspects of the invention may be practiced; and

FIG. 9 shows an example storage system capable of implementing various aspects of the present invention.

### DETAILED DESCRIPTION

According to some embodiments, a website can be produced by publishing various forums where messages can be posted. The forums can be directed to specific topics. The topics can include, for example, different illnesses. The topics can also include different professions, different common life experiences, and different roles and relationships, such as father, mother, daughter, brother. The topics can also be specific intersections of more general topics, for example, spouse of an Alzheimer's patient. Users can post messages to the website, which can determine forums that are directed to topics may be relevant to the message. Users can be prompted with suggests to post to various forums as appropriate.

The website can also include forums specific to each user, such as personal forums. The personal forums can also be directed to topics, such as a personal spouse forum. The messages posted to personal forums can be given permissions, which can allow specific other users or other groups of users various levels of access to the message. For example, a message can be given a permission that allows two specific other users to read and comment on the message. Permissions can be granted at a message level or on a forum level. Forums can also be published combining several personal forums for which all the users have access. For example, three users can allow access to each of their personal forums to each other. A separate forum can be published that shows the messages posted to the three users' personal forums.

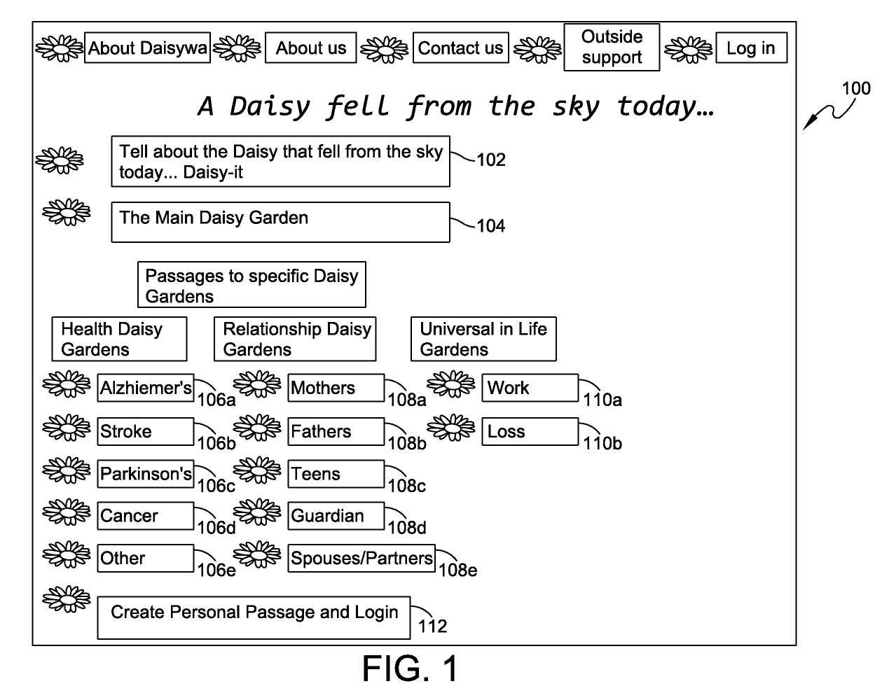

FIG. 1 shows a sample main webpage 100 incorporating various aspects of the present invention. The main webpage 100 allows a user to make a variety of selections, such as to post a message (box 102), view other users' messages (box 104), access forums relating to a specific health issue (boxes 106a-106e), access forums relating to a particular relationship (boxes 108a-108e), access forums relating to particular life issues (boxes 110a-110b), and create a personal login (box 112). In the example main webpage 100 shown in FIG. 1, a message is referred to as a “daisy” and the forums are called “gardens.”

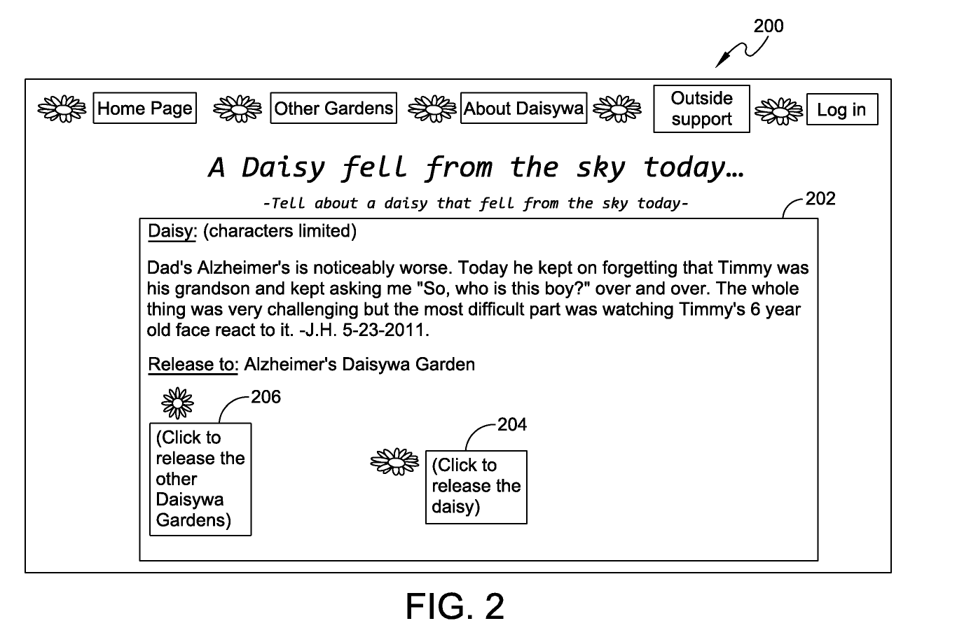

According to one embodiment, a user may select box 102 to post a message. In one embodiment, selecting box 102 loads a new webpage including a textbox in which the user may enter a post. FIG. 2 shows a textbox webpage 200 including a textbox 202, and first 204 and second 206 selection boxes. The first selection box 204 allows the user to post the message on a forum specific to the topic of the post. Here, the message is related to Alzheimer's disease, and selecting the box 204 will post the message an Alzheimer's disease forum. In one example, the Alzheimer's disease forum is referred to as the “Alzheimer's Daisywa Garden.” The second selection box 206 allows the user to post the message to another forum. In one example, selecting box 206 will post the message to the general forum, which is referred to in this example as “The Daisywa Garden.” According to one embodiment, all messages are posted to the general forum. In another example, selecting box 206 will lead to a webpage including other potential forums to which the user may choose to post the message. In one example, a message is called a “daisy,” and posting a message is referred to as “releasing the daisy.”

According to one embodiment, the user may access the textbox webpage 200 after selecting a specific forum on the main webpage 100. For example, on the main webpage 100, the user may select the Alzheimer's forum box 106a. The selection of the Alzheimer's forum box 106a will link the user to an Alzheimer's webpage from which the user may choose to post a message. If the user accesses the textbox webpage 200 through a specific forum, such as the Alzheimer's forum, then the textbox webpage 200 will include a box to allow the user to post the message to that forum (here, box 204).

In one embodiment, when the textbox webpage 200 is accessed directly from the main webpage 100, and the message entered in the textbox is searched for keywords to determine one or more forums the user might like to post the message to. In one example, a pop-up box may appear asking the user if the user would like to post the message to a specific forum based on the keyword search.

According to some embodiments, selecting the box 102 on the main webpage 100 causes a pop-up box to appear for the user to enter a message. In one example, selecting the box 102 on the main webpage 100 causes the main webpage 100 to reload with a textbox in which the user may enter a message.

According to one aspect, a user may access a website to chronicle events that occur in the user's life. An event may be a moment in time that a user processes on a personal level. In one example, an event may be life-changing to the user, but friends, family and co-workers may not be fully understand the effect of the event on the user. The event may be small, but meaningful, to the user. An event may also be a major event, such as discovering that someone the user cares about is ill, or the loss of a loved one. When a user experiences a major life event, family, friends and co-workers often pause and offer assistance and condolences. When a user experiences a minor event, however, the user may not have support from others who can understand the user's experience. According to one feature, the website may provide support to users for minor (as well as major) events by allowing the user to connect with others who are experiencing similar events. The website provides an outlet for users to post messages about events. The therapeutic support the website may provide may take less than a minute, or a user may choose to stay on the website for much longer. According to one feature, the website provides a place for a user to let go of an event (for example, by posting a message about it), and to process the event and acknowledge the occurrence so the user can move forward. Some life transitions occur in small incremental steps, and the website can provide a forum for users to posts messages about incremental life events and to learn about other users' experiences.

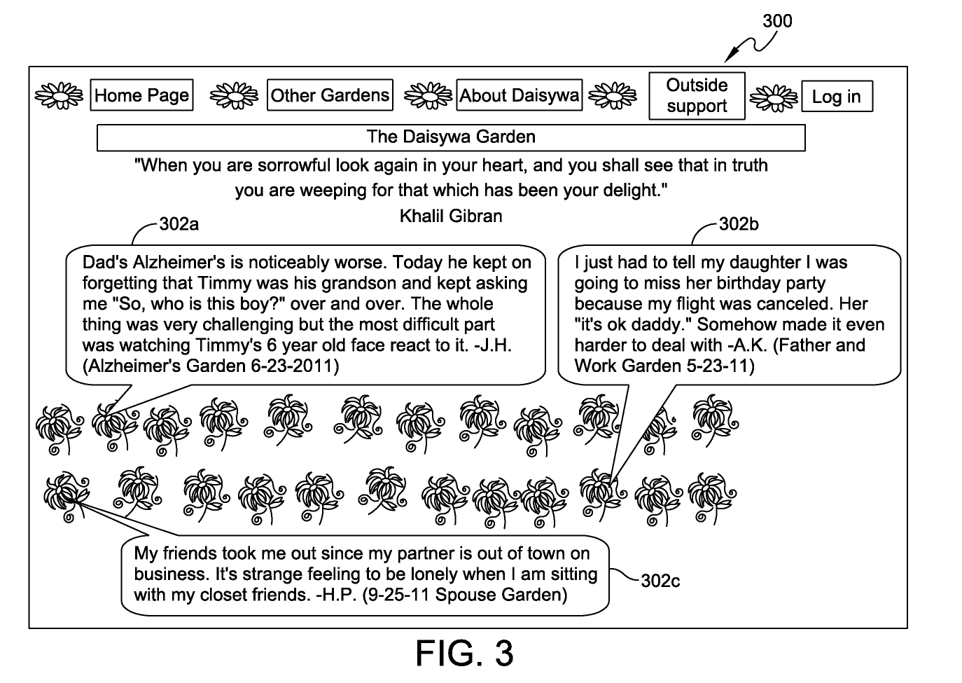

FIG. 3 shows a webpage 300 of a general forum to which users may post messages, according to an embodiment of the invention. As shown in the illustrative embodiment of FIG. 3, the general forum webpage 300 is called “The Daisywa Garden” and typical posts include thoughts, feelings, and/or events that users have recently experienced. According to some embodiments, the general forum webpage may have other names. According to one feature, a post is called a “daisy” and the webpage graphically displays a daisy for each post. Thus, in the illustrated example, each daisy represents a user post. The message 302a-302c in the post may be displayed when a user positions the cursor over the daisy or when a user clicks on the daisy. In some embodiments, user posts may be represented by other graphics or icons.

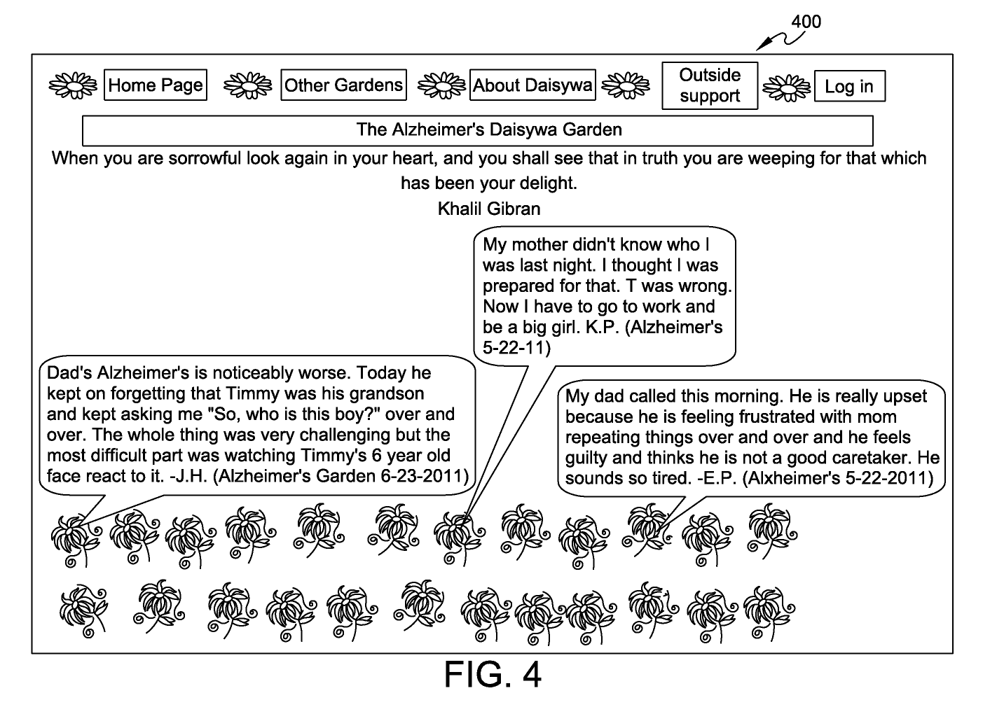

FIG. 4 shows a webpage 400 of an Alzheimer's disease forum according to one embodiment of the invention. According to the illustrated example, the Alzheimer's disease forum webpage 400 is called “The Alzheimer's Daisywa Garden.” Example posts to the Alzheimer's disease forum webpage 400 include thoughts, feelings, and/or events relating to Alzheimer's disease that users experienced. According to one feature, the Alzheimer's disease forum page 400 is for any user who has Alzheimer's disease or has a relative or friend with Alzheimer's disease.

In one example, a user may post messages about events related to living with a person with Alzheimer's disease. For example, a user may post about a day when the patient forgets where their keys are, a day when the patient forgets to get dressed, a day when the patient forgets how to get dressed, a moment when the patient forgets a loved one's name, and a moment when the patient forgets who a loved one is. The patient, family, friends, and/or caretakers may suffer at some level for each of the events. According to one feature, the Alzheimer's disease forum provides a place for the user to post about the events, which can help the user to move forward. According to one feature, the Alzheimer's disease forum can help ease a user's sense of loneliness by allowing the user to read posts about other people's experiences. According to some examples, using the forum may have a therapeutic effect on some users.

According to some embodiments the website includes separate webpages for different users depending on the user's relationship to a person with Alzheimer's disease. For example, the website may include a page for patients with Alzheimer's disease to post messages, another page for spouses of patients with Alzheimer's disease to post messages, and another page for children of patients with Alzheimer's disease to post messages. In this manner, people undergoing similar experiences may connect with each other by reading messages posted by people in similar positions.

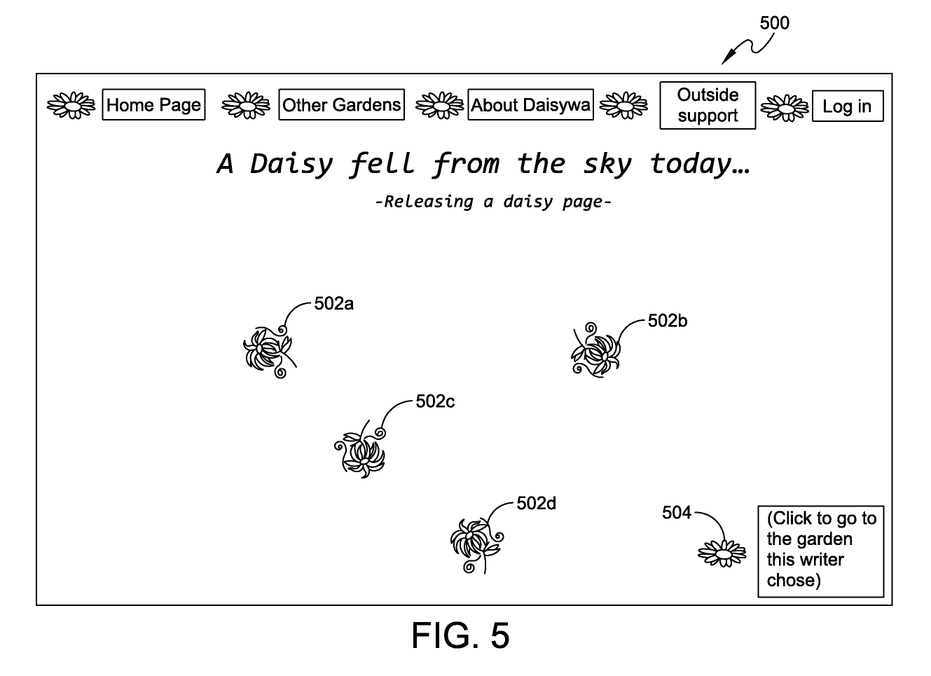

FIG. 5 shows a transitional webpage 500, which may be presented after a user posts a message, according to one embodiment of the invention. For example, referring back to FIG. 2, after a user selects box 204 or box 206 to post a message to a forum (or “release a daisy”), the transitional webpage 500 is displayed to the user. In one example, the transitional webpage 500 is animated. The daisies 502a-502d shown on the transitional webpage 500 may be falling downward or moving around the screen in various directions. Music may be played while the transitional webpage 500 is displayed. In one example, meditative or calming music is played. In some examples, the user may select the type of music played. In some examples, the user may select the specific music played. According to one feature, when the user wants to return to the forum or “garden” to which the user posted the message, the user selects the stationary daisy icon 504.

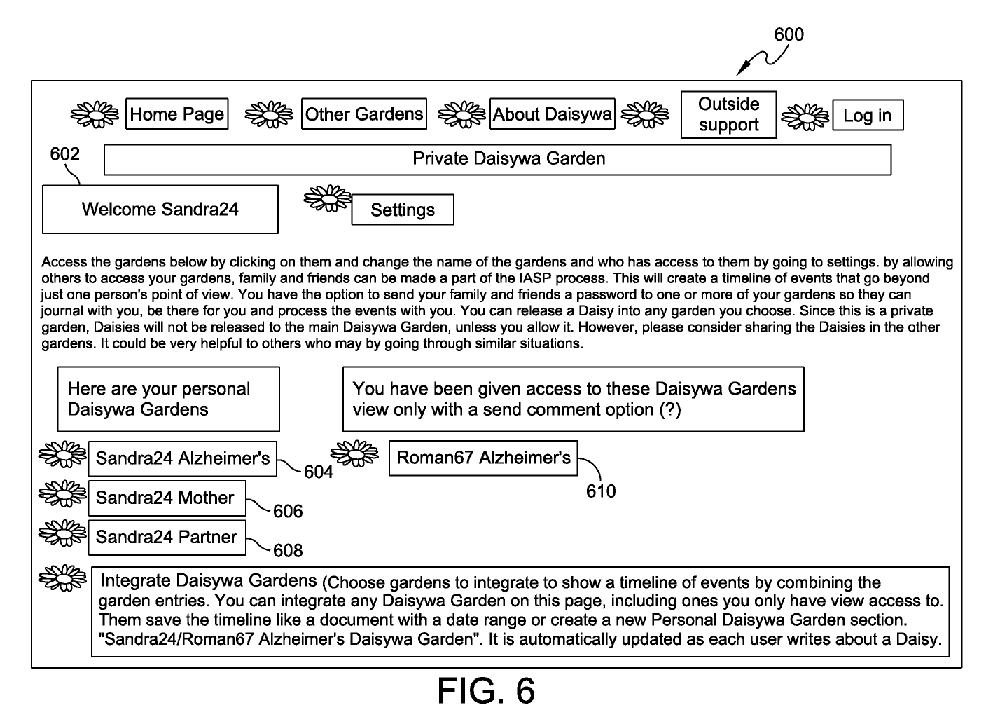

FIG. 6 shows a private user webpage 600 according to one embodiment of the invention. According to one feature, the private user webpage 600 allows a user to create private messages and post the messages to the private user webpage 600. In this manner, a user may use the website for private personal journal posts without sharing the posts with a group. According to one feature, the user can use the website to journal an event, acknowledge the significance of the event to herself, and stop and process the event and emotions or thoughts the event evokes. This process may be referred to as JASP (Journal, Acknowledge, Stop, Process).

According to the illustrative embodiment, the private user webpage 600 is the webpage for a user named “Sandra24” (box 602). The user Sandra24 has created three personal forums relevant to three different aspects of her life: Sandra24 Alzheimer's (box 604), Sandra24 Mother (box 606) and Sandra24 Partner (box 608). Each of these forums is a personal “garden” for Sandra 24, where she can post messages and she can choose who has access to each garden. In one example, she keeps one or more of the forums 604, 606 and 608 private. In one example, Sandra24 specifically chooses selected other users who may view her posts. In one example, Sandra24 elects to make her posts public and the posts are published on a group-specific public forum. For example, Sandra24's Alzheimer's posts at box 604 may be published on the Alzheimer's disease forum 400 described with reference to FIG. 4. In another example, Sandra24 elects to make her posts public and they are published on the general public forum 300 described with reference to FIG. 3.

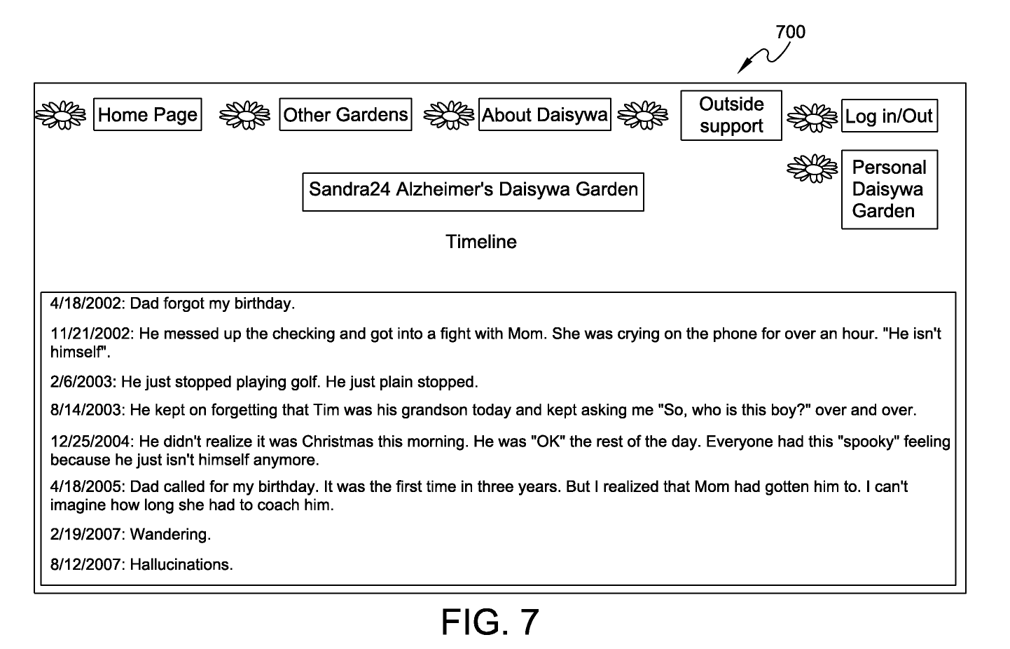

According to one feature, the user can select a specific private forum and posts can be displayed chronologically to show a timeline of events. FIG. 7 shows a webpage including a chronological list of personal posts according to an illustrative embodiment. In one example, all of the posts are private to the user. In one example, some of posts are private and some of the posts are posts the user shared with others. The user may have shared the posts either with specific individuals or with selected public forums. In one example, all of the posts are posts the user shared with others. In one example, the user chooses to display an Integrated Process Specific Timeline, in which the user's posts and the posts of one or more other users are displayed in a timeline. The posts may be regarding experiences relevant to the same or similar life processes.

According to one feature, the website allows a user to give other users access to the user's private forums. In the illustrative example of FIG. 6, user Sandra24 has access to a private forum 610 created by another user, Roman67, related to Alzheimer's disease. In some examples, family members or friends who know each other may elect to share forums with each other. In some examples, users may become acquainted through their posts on public forums, such as the general forum 300 described with reference to FIG. 3 or the Alzheimer's forum 400 described with reference to FIG. 4, and the users may choose to share more private messages.

According to one embodiment, users may integrate their forums to create personal forums or “gardens.” For example, when several users have access to each other's private Alzheimer's posts, one or more of the users may integrate all the posts in one display. In one example, the posts are aggregated and displayed chronologically. In the illustrative example of FIG. 6, Sandra24's Alzheimer's posts (box 604) may be combined with Roman67's Alzheimer's posts to show a timeline of events. In one embodiment, one user with access to one or more other users' posts may create a new private personal forum or “garden” that automatically updates with posts from the other users whose posts the user has access to. According to one feature, the user may elect to have the posts displayed chronologically in another window.

According to some embodiments, the website may include forums for spouses and partners. The website may include different forum web pages for people in different lines of work. For example, the website may include a forum for teachers, a forum for doctors, a forum for attorneys, a forum for salespeople, and many other forums for other types of work. The website may include forums for people who have lost someone, such as a friend or a family member.

### Example Computer Implementations

Processes described above are merely illustrative embodiments of systems that may be used to create and manage a life experience website according to various aspects of the present invention. Such illustrative embodiments are not intended to limit the scope of the present invention, as any of numerous other implementations for performing the invention. None of the claims set forth below are intended to be limited to any particular implementation, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

A computer system may be a general-purpose computer system that is programmable using a high-level computer programming language. Computer system may be also implemented using specially programmed, special purpose hardware. In a computer system there may be a processor that is typically a commercially available processor such as the well-known Pentium class processor available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). Components may also be distributed in a cloud-based computing system as is known in the art.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (CSharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (QUI) or perform other functions). Various aspects of the invention may be implemented as programmed or non-programmed elements, or any combination thereof.

Further, on each of the one or more computer systems that include one or more components of website 100, each of the components may reside in one or more locations on the system. For example, different portions of the components of website 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

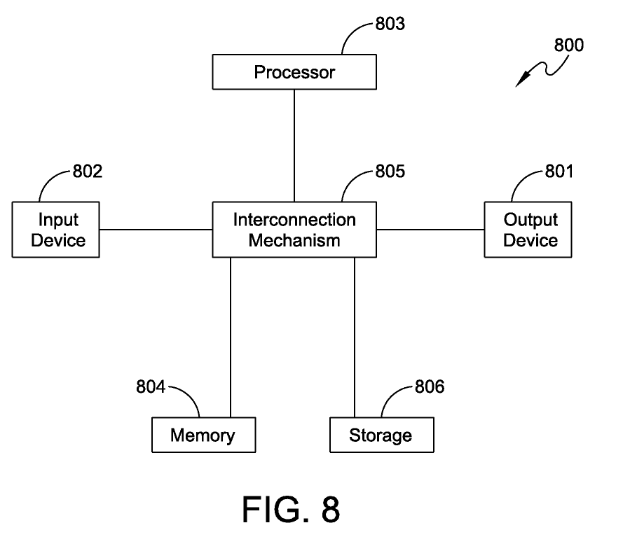

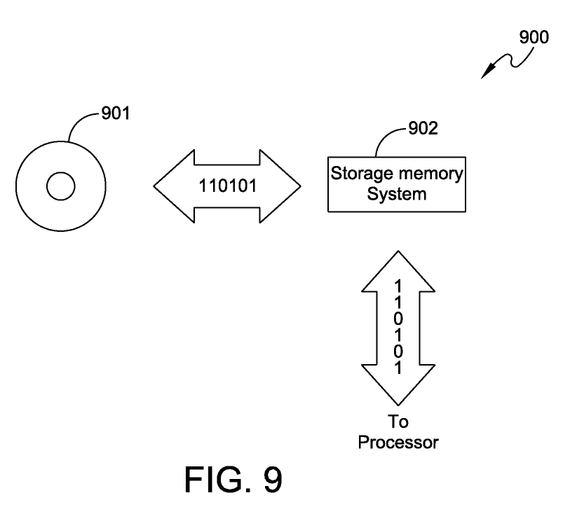

Any number of systems of the website described herein may be implemented on a computer system described below in relation to FIGS. 8 and 9. In particular, FIG. 8 shows an example computer system 800 used to implement various aspects. FIG. 9 shows an example storage system that may be used.

System 800 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the location-based services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 800 such as that shown in FIG. 8. The computer system 800 may include a processor 803 connected to one or more memory devices 804, such as a disk drive, memory, or other device for storing data. Memory 804 is typically used for storing programs and data during operation of the computer system 800. Components of computer system 800 may be coupled by an interconnection mechanism 805, which may include one or more busses (e.g., between components that are integrated within a same machine) and/or a network (e.g., between components that reside on separate discrete machines). The interconnection mechanism 805 enables communications (e.g., data, instructions) to be exchanged between system components of system 800. Computer system 800 also includes one or more input devices 802, for example, a keyboard, mouse, trackball, microphone, touch screen, and one or more output devices 801, for example, a printing device, display screen, and/or speaker. In addition, computer system 800 may contain one or more interfaces (not shown) that connect computer system 800 to a communication network (in addition or as an alternative to the interconnection mechanism 805).

The storage system 806, shown in greater detail in FIG. 9, typically includes a computer readable and writeable nonvolatile recording medium 901 in which signals are stored that define a program to be executed by the processor or information stored on or in the medium 901 to be processed by the program. The medium may, for example, be a disk or flash memory. Typically, in operation, the processor causes data to be read from the nonvolatile recording medium 901 into another memory 902 that allows for faster access to the information by the processor than does the medium 901. This memory 902 is typically a volatile, random access memory such as a dynamic random access memory (DRAM) or static memory (SRAM). It may be located in storage system 806, as shown, or in memory system 804, not shown. The processor 803 generally manipulates the data within the integrated circuit memory 804, 902 and then copies the data to the medium 901 after processing is completed. A variety of mechanisms are known for managing data movement between the medium 901 and the integrated circuit memory element 804, 902, and the invention is not limited thereto. The invention is not limited to a particular memory system 804 or storage system 806.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 800 is shown by way of example as one type of computer system upon which various aspects of the invention may be practiced, it should be appreciated that aspects of the invention are not limited to being implemented on the computer system as shown in FIG. 8. Various aspects of the invention may be practiced on one or more computers having a different architecture or components that that shown in FIG. 8.

Computer system 800 may be a general-purpose computer system that is programmable using a high-level computer programming language. Computer system 800 may be also implemented using specially programmed, special purpose hardware. In computer system 800, processor 803 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used. One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (CSharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for producing a website, the method comprising:
publishing a website including a plurality of forums for users to post messages, wherein each of the plurality of forums is directed to a specific topic;
receiving a message to post on the website;
associating the message with at least one of the specific topics; and
providing an option to post the message to each of the plurality of forums directed to the at least one of the specific topics.

2. The method of claim 1, further comprising associating a first message received from a first user with a first specific topic and a second message received from a second user with a second specific topic.

3. The method of claim 1, wherein associating the message with at least one of the specific topics comprises:
parsing the message for keywords; and
determining the at least one of the specific topics related to the keywords.

4. The method of claim 1, wherein associating the message with at least one of the specific topics comprises:
receiving, from a user, an indication of the at least one of the specific topics with which the message is associated.

5. The method of claim 1, further comprising presenting, to a user, a plurality of messages posted by the user, the messages directed to at least one of the specific topics, wherein the messages are ordered chronologically according to a time of posting of each message.

6. The method of claim 1, wherein the plurality of forums includes a forum specific to each user.

7. The method of claim 6, further comprising receiving, from a user, permission for one or more other users to access the forum specific to the user.

8. The method of claim 7, further comprising publishing a forum comprising a subset of the forums specific to the users, wherein the subset comprises forums specific to the users for which all the users to which the forums are specific have permission to access all other forums in the subset.

9. A distributed computer system adapted to produce a website, the distributed computer system comprising modules configured for:
publishing a website including a plurality of forums for users to post messages, wherein each of the plurality of forums is directed to a specific topic;
receiving a message to post on the website;
associating the message with at least one of the specific topics; and
providing an option to post the message to each of the plurality of forums directed to the at least one of the specific topics.

10. The system of claim 9, further comprising a module configured for associating a first message received from a first user with a first specific topic and a second message received from a second user with a second specific topic.

11. The system of claim 9, wherein associating the message with at least one of the specific topics comprises:
parsing the message for keywords; and
determining the at least one of the specific topics related to the keywords.

12. The system of claim 9, wherein associating the message with at least one of the specific topics comprises:
receiving, from a user, an indication of the at least one of the specific topics with which the message is associated.

13. The system of claim 9, further comprising a module configured for presenting, to a user, a plurality of messages posted by the user, the messages directed to at least one of the specific topics, wherein the messages are ordered chronologically according to a time of posting of each message.

14. The system of claim 9, wherein the plurality of forums includes a forum specific to each user.

15. The system of claim 14, further comprising a module configured for receiving, from a user, permission for one or more other users to access the forum specific to the user.

16. The system of claim 15, further comprising a module configured for publishing a forum comprising a subset of the forums specific to the users, wherein the subset comprises forums specific to the users for which all the users to which the forums are specific have permission to access all other forums in the subset.

17. A non-transitory computer-readable medium comprising computer-executable instructions that, when executed on a processor, perform a method for producing a website, the method comprising acts of:
publishing a website including a plurality of forums for users to post messages, wherein each of the plurality of forums is directed to a specific topic;
receiving a message to post on the website;
associating the message with at least one of the specific topics; and
providing an option to post the message to each of the plurality of forums directed to the at least one of the specific topics.
